(19) United States
(12) Patent Application Publication
(10) Pub. No.: US 2017/0005815 A1
(43) Pub. Date: Jan. 5, 2017

(54) Match-making Application that is integrated into Online Social Networks

(71) Applicant: Erez Melnik, Tel Aviv (IL)

(72) Inventor: Erez Melnik, Tel Aviv (IL)

(21) Appl. No.: 14/790,532

(22) Filed: Jul. 2, 2015

(51) Int. Cl. H04L 12/18; H04L 29/08

(52) U.S. Cl. CPC H04L 12/1818; H04L 67/306

(57) ABSTRACT

A math-making application, which is integrated into online social networks, that enables a matchmaking user to initiate an acquaintance between two nominated friends for a particular purpose.

### TECHNICAL FIELD

The present invention refers to a match-making application that is integrated into online social networks. More specifically, a dating match-making application, which is integrated into online social networks, that enables a matchmaking user to initiate an acquaintance between two nominated friends for a particular purpose.

### BACKGROUND ART

Users of online social networks such as Facebook, VKontakt, Odnoklassniki, Twitter, LinkedIn and the like have lists of friends. Users sometimes wish to initiate a romantic or other acquaintance between two individuals on his or her friends list. At present, such a user must write a message to each of these friends suggesting that User 1 meet User 2, which is cumbersome and hinders the initiative. The present invention offers a response to this need, and describes a dating application that is integrated into social networks.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 depicts a home page (2) on a social network, including the activation icon (1) of the dating application.

FIG. 2 depicts an example of an objectives menu (4) and a friends list (5).

FIGS. 3 and 4 depict a message (6) that the nominated friends receive.

### THE INVENTION

The main objective of the present invention is to provide a dating application that is integrated into online social networks. Any user can add the dating application to his or her social network profile. The dating application can appear on the main page of the profile as an icon or in any other form.

Should a user (hereinafter the “matchmaking user”) believe that User 1 and User 2, who are on his or her friends list, should make a romantic acquaintance, that user may initiate contact with two nominated (suggested) friends using the dating application.

The dating application may include one or more of the following options: activation icon (1) that appears on the main page of the user's profile (2). When the activation icon (1) is clicked on, a box opens up containing the main menu (3), which may include the objectives menu (4) and the user's friends list (5) as sub-menus. The objectives menu (4) includes a list of possible objectives, for which the matchmaking user presumes two of his or her social network friends should meet.

The main objective is, of course, a romantic acquaintance, a constant and great need for many people. Nevertheless, the objectives list can also include additional objectives such as common hobbies, business connections and a variety of other objectives.

The matchmaking user chooses one of the objectives from the menu (4) and selects the two acquaintance nominees (5A and 5B) (“nominated friends”) from the friends list (5). As soon as the two nominated friends (5A+5B) are selected, the dating application sends a message (6) to their social networking profiles notifying them that their matchmaking user has suggested that they become acquainted for the objective he or she has chosen.

The dating application can also include an option that enables the matchmaking user to add a written message, a photo or any other addition to the message (6), which can only take the form of an icon, as depicted in the drawings. The dating application can also include an option that enables a user to contact a friend in order to request that friend to initiate an acquaintance between him or her to a specific friend on the friend's friend list.

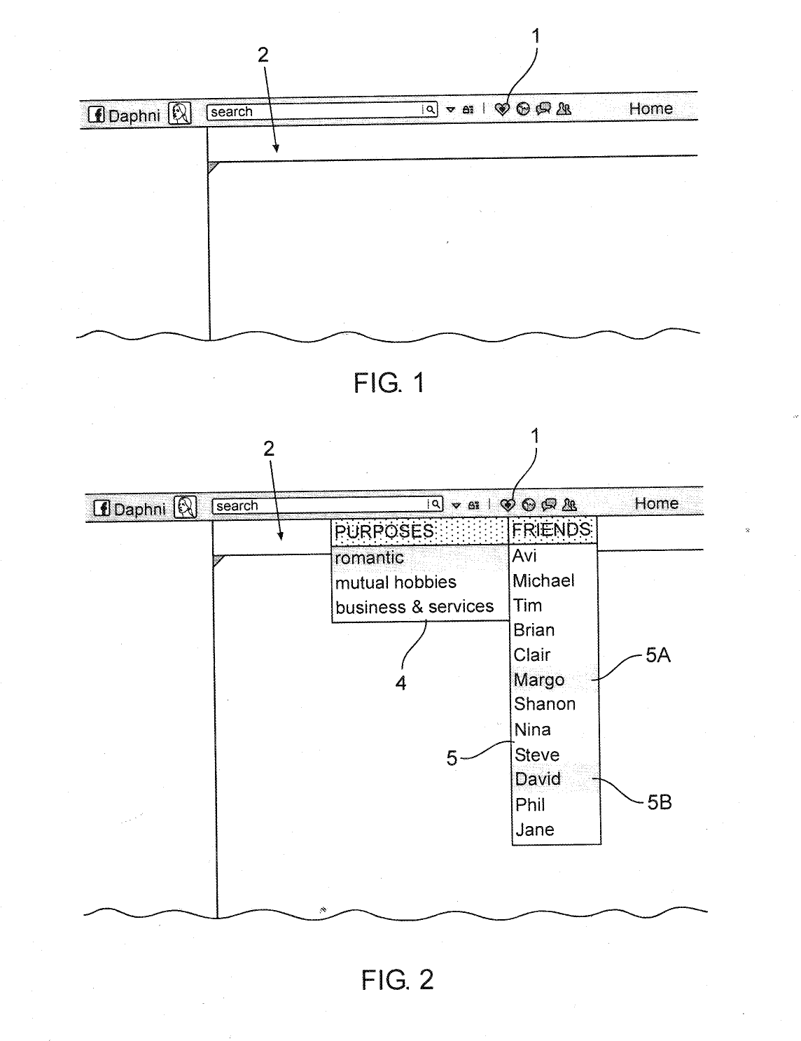

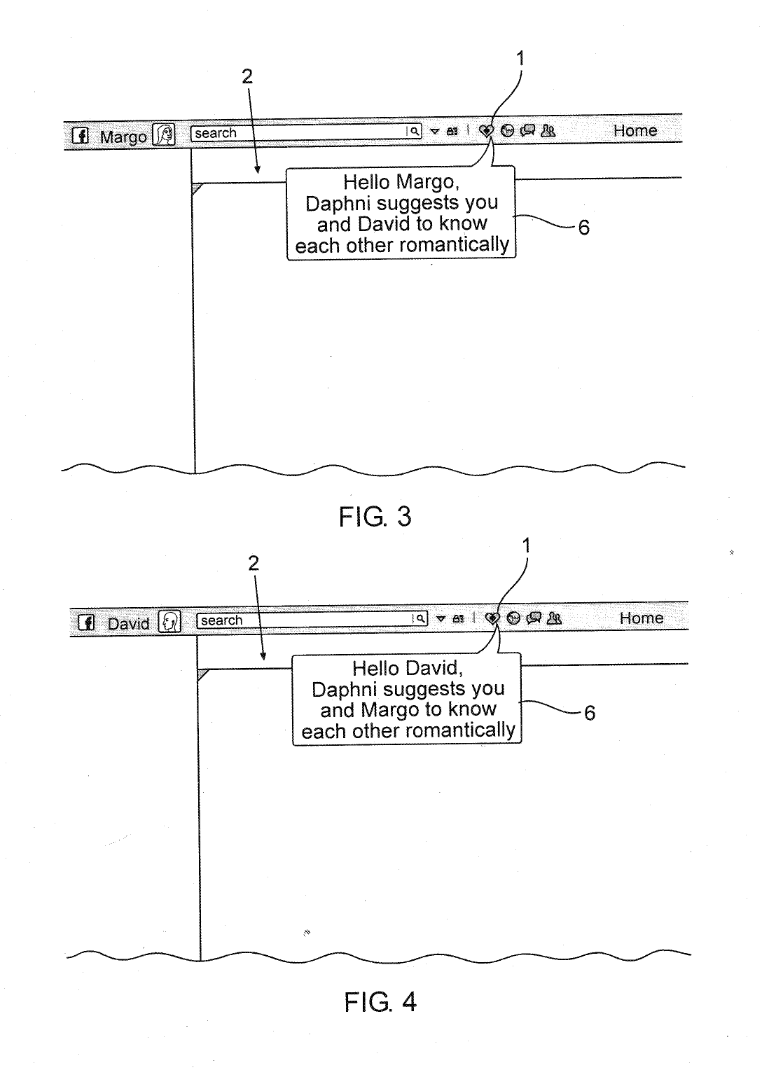

FIG. 1 presents an example of the main Facebook page (2) of a user named DAPHNI, including the activation icon (1) of the dating application. FIG. 2 depicts the objectives menu (4) and the friends list (5) that are displayed after clicking on the activation icon (1) after “romantic purposes” was selected from the objectives menu and after two nominated friends (5A and 5B) were selected as well. FIGS. 3 and 4 depict the message (6) that the nominated friends (5A and 5B) receive.

The dating application meets important existing needs and removes both technical and psychological obstacles. The very existence of the dating application makes matchmaking a socially legitimate activity. In addition, the dating application makes this activity easy and fast by bypassing the need to write lengthy, exhausting and detailed messages. It also enables a user who identifies a possible match for one of his or her friends on another user's friends list to request that friend to initiate an acquaintance between the two.

What is claimed is:

1. A match making application, which is integrated into online social networks, that enables a matchmaking user to initiate an acquaintance between two nominated friends for a particular purpose.
